(19) United States
(12) Patent Application Publication
(10) Pub. No.: US 2014/0344702 A1
(43) Pub. Date: Nov. 20, 2014

(54) ADAPTIVE TIMING SUPPORT FOR PRESENTATIONS

(71) Applicant: Microsoft Corporation, Redmond, WA (US)

(72) Inventors: Darren K. Edge, Beijing (CN); Hong Z. Tan, Beijing (CN)

(73) Assignee: Microsoft Corporation, Redmond, WA (US)

(21) Appl. No.: 13/898,338

(22) Filed: May 20, 2013

(51) Int. Cl. G06F 3/0484

(52) U.S. Cl. CPC G06F 3/0484
USPC 715/730

(57) ABSTRACT

Techniques for providing adaptive timing support may reduce the cognitive load on a presenter during a presentation by tracking the pace of the presentation on behalf of the presenter. A time interval may be initially allocated to each of multiple sections of a presentation based on a target time duration for the presentation. The actual presentation time duration of a section may be monitored during coverage of the section. Following the detection of an advance to another section of the presentation, the allocated time interval established for each of one or more remaining sections in the presentation may be updated based on a time difference between the actual presentation time duration and the allocated time interval of the section.

### BACKGROUND

A presentation application may be used by a presenter to provide visual information as the presenter delivers a lecture on a topic. The visual information may be delivered in the form of a slideshow. However, a common problem faced by presenters who use presentation applications may be the difficulty in pacing the slideshow and the accompanying verbal narration to finish a presentation on time. In some instances, a presenter may inadvertently devote disproportionate amounts of time to certain slides in the slideshow, thereby resulting in the presenter going over the allocated time for the presentation or being forced to skip some of the slides in the slideshow. In other instances, the presenter may unintentionally adopt a faster than rehearsed pace while presenting a lecture using a slideshow, while may result in the presenter failing to effectively communicate ideas related to lecture topics. Although the presenter may return to certain slides in the slideshow in certain instances, such circuitous coverage may disrupt the temporal and topical flow of the presentation. As a result, the effectiveness and the cohesiveness of the presentations may be reduced.

### SUMMARY

Described herein are techniques for providing timing support that adaptively changes during a delivery of a presentation. The adaptive timing support may provide timing signals to ensure that a presenter finishes the presentation in a timely fashion while covering all the sections in the presentation. For example, the sections of the presentation may correspond to slides in a slide deck. The timing signals may be dynamically adjusted based on a corresponding amount of time that the presenter actually spends on each section of the presentation. In this way, each of the timing signals may cue the presenter to advance to a subsequent section of the presentation, while at the same time providing the presenter with some degree of freedom in choosing the amount of time to spend on each section. Accordingly, by using the timing signals to move through sections, the presenter may finish the presentation on time without resorting to skipping sections. The timing signals may be conveyed to the presenter via a feedback device. The feedback device may generate visual, aural, speech, and/or haptic stimulations that have spatial, perceptual, and/or temporal characteristics.

The techniques for providing adaptive timing support may reduce the cognitive load on a presenter during a presentation by tracking the pace of the presentation on behalf of the presenter. Accordingly, effort on the part of the presenter to mentally compare the actual progress and the planned progress of a presentation may be eliminated. Instead, the presenter may rely on the timing signals to advance through the sections of a presentation to finish on time while still maintaining a degree of freedom with respect to the actual pace for presenting each section. As such, the presenter may be able to devote more mental concentration to the content of the presentation such that the presentation becomes more natural and fluid.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an example scheme for implementing adaptive timing support for providing a presentation.

FIG. 2 is an illustrative diagram that shows example components of an adaptive time engine that provides timing support, as well as example components of a feedback device that provides feedback signals.

FIG. 3 shows an illustrative user interface page for setting presentation timing intervals of multiple slides in a slideshow.

FIG. 4 shows an illustrative user interface page for providing timing signals during the presentation of a slideshow.

FIG. 5 is a flow diagram that illustrates an example process for adaptively providing timing signals during the presentation of a slideshow.

FIG. 6 is a flow diagram that illustrates an example process for setting the presentation time intervals of multiple slides in a slideshow.

FIG. 7 is a flow diagram that illustrates an example process for providing timing signals with respect to a section of the presentation and the entire presentation.

### DETAILED DESCRIPTION

Described herein are techniques for providing timing support that adaptively changes during a delivery of a presentation. As used herein, delivery may refer to an act of displaying the presentation to an audience, in which the person delivering the presentation verbally explains the text, images, and/or multimedia content in each section of the presentation. In most instances, the person delivering the presentation may explain the sections in a linear order. However, the person may also skip through one or more sections or return to previous explained sections depending on circumstances. The adaptive timing support may provide timing signals to ensure that a presenter finishes the presentation on time while covering all the sections in the presentation. For example, the sections of the presentation may correspond to slides in a slide deck. The timing signals may be dynamically adjusted based on an amount of time that the presenter actually spends on each section of the presentation. In this way, each of the timing signals may cue the presenter to advance to a subsequent section of the presentation, while at the same time providing the presenter with some degree of freedom in choosing the amount of time to spend on each section. Accordingly, by using the timing signals to move through sections, the presenter may finish the presentation on time without resorting to skipping sections.

The timing signals may be conveyed to the presenter via a feedback device. The feedback device may generate visual, aural, speech, and/or haptic stimulations that have spatial, perceptual, and/or temporal characteristics. For instance, the haptic feedbacks may be in the form of vibrations. Other haptic feedbacks may include changes in a physical size, a shape, a temperature, compressibility, a resistance, and/or flexibility of at least a portion of the feedback device to communicate the timing signals. The feedbacks may be passive, i.e., the user performs an action to query for a timing signal. Alternatively, the feedbacks may be active, i.e., the feedbacks may be periodically presented to the user without user initiation.

The techniques may be implemented in a scenario in which the presentation has a target time duration. The target time duration may be a total presentation time that the presenter is seeking to achieve for the verbal delivery of the presentation. The target time duration may be allocated among the number of sections in the presentations so that each section has an ideal allocated time interval. The timing signals may indicate approach, completion, and/or overrun with respect to the ends of the time intervals. However, as the presenter delivers the presentation, the allocated time intervals for the remaining sections may be recalculated based on the actual time used by the presenter to present the one or more previous sections. The recalculation may result in temporal adjustments to the timing signals that are provided to the presenter. Such recalculations may be carried out iteratively so that the timing signals consistently adapt to the time usage of the presenter with respect to each section of the presentation.

The techniques may also be implemented with respect to other scenarios. For example, for a presentation that is in the form of an informal meeting between multiple participants, the topics of the meeting may be determined by an agenda in which each topic is allocated a corresponding discussion time interval. In such an example, the timing signals may be adaptively adjusted based on the actual time spent in discussing each topic.

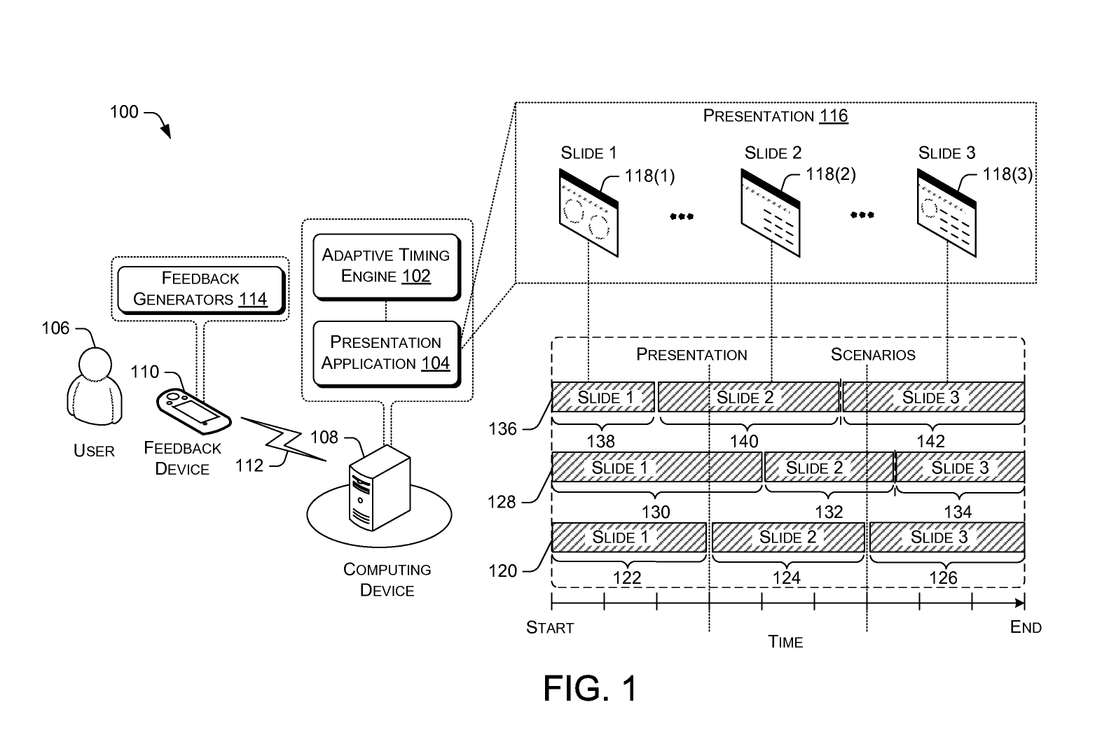

The techniques for providing adaptive timing support may reduce the cognitive load on a presenter during a presentation by tracking the pace of the presentation on behalf of the presenter. Accordingly, effort on the part of the presenter to mentally compare the actual progress and the planned progress of a presentation may be eliminated. Instead, the presenter may rely on the timing signals to advance through the sections of a presentation to finish on time, while still have some degree of freedom with respect to the actual pace for presenting each section. Examples of techniques for using adaptive timing signals to support the delivery of a presentation in accordance with various embodiments are described below with reference to FIGS. 1-7.

### Example Scheme

FIG. 1 is a block diagram that illustrates an example scheme 100 for implementing adaptive timing support for providing a presentation. The example scheme 100 may include an adaptive timing engine 102 that supports a presentation application 104. In some embodiments, the adaptive timing engine 102 may be a part of the presentation application 104. In other words, the adaptive timing engine 102 may be a function library that is used by the presentation application 104 to perform functions. In other embodiments, the adaptive time engine 102 may be a separate application and/or script called by the presentation application 104 to provide adaptive presentation timing. For example, the adaptive timing engine 102 may provide application programming interfaces (APIs) that enable the presentation application 104 to call the adaptive timing engine 102 to perform functions.

The presentation application 104 may be a slideshow application that enables a user 106 to create, rehearse, and/or delivery a presentation with multiple sections using a deck of slides. Each of the slides in the slide deck may include graphs, texts, and/or multimedia content that pertain to one or more subject matter. The adaptive timing engine 102 and the presentation application 104 may be implemented by a computing device 108. In some embodiments, the computing device 108 may be a general purpose computer, such as a desktop computer, a tablet computer, a laptop computer, one or more servers, and so forth. However, in other embodiments, the computing device 108 may be one of a smart phone, a game console, a personal digital assistant (PDA), or any other electronic device that interacts with a user via a user interface. In still other embodiments, the computing device 108 may be replaced by one or more servers that are part of a computing cloud.

The adaptive timing engine 102 may provide timing signals to ensure that the user 106 finishes the presentation on time while covering all the sections in the presentation. The timing signals may be dynamically adjusted based on an amount of time that the user 106 actually spends on each slide of the presentation. In this way, each of the timing signals may cue the user 106 to advance to a subsequent slide of the presentation, while at the same time providing the user 106 with some degree of freedom in choosing the amount of time to spend on each slice. Accordingly, by using the cues to move through sections, the user 106 may finish the presentation on time without resorting to skipping sections.

The adaptive timing engine 102 may space the timing signals based on a target time duration. The target time duration may be a total presentation time that the user 106 is seeking to achieve for the verbal delivery of the presentation. The adaptive timing engine 102 may allocate the target time duration among the number of slides in the presentations so that each slide has an allocated time interval. The time intervals may be allocated equally among the slides, or disproportionally allocated among the slides based on specific user inputs. In other embodiments, the adaptive timing engine 102 may use machine learning techniques. The machine learning techniques may enable the adaptive timing engine 102 to infer a time interval to allocate to each of the slides based on the amount of text, images, notes, and/or embedded multimedia content in each slide. For example, the adaptive timing engine 102 may use machine learning to analyze the content of each slide, and allocate similar time intervals to slides that have similar amounts and/or types of content. In another example, the adaptive timing engine 102 may project a user allocated time interval for a slide to another slide that has similar amounts and/or types of content. The adaptive timing engine 102 may be configured to provide timing signals with respect to an approach, a completion, and/or an overrun with respect to the ends of the time intervals, in which the timing signals may be provided continuously, periodically, or with systematically varying intervals. For example, the adaptive timing engine 102 may provide a first timing signal when the coverage of a slide by the user 106 is within 20 seconds of the end of a time interval. The adaptive timing engine 102 may provide a second timing signal when the coverage of the slide by the user 106 is at the end of the time interval. Further, a third timing signal may be provided by the adaptive timing engine 102 when the coverage of the slide by the user 106 is 20 seconds past the end of the time interval. As used herein, coverage of a section, e.g., slide, may refer to an act of displaying the slide to an audience, in which the person covering the slide verbally explains the text, images, and/or multimedia content associated with the slide, in which the verbal explanation may include pauses or periods of silence. Alternatively, coverage of a section may refer to the discussion of a topic even when no visual slides are available.

Further, as the user 106 delivers the presentation, the adaptive timing engine 102 may allocate the time intervals for the remaining slides based on the actual time remaining using the same existing time distributions. The actual time remaining may be the maximum time minus the actual time intervals used by the user 106 to present the one or more previous slides. The reallocation may result in temporal adjustments to the timing signals that are provided to the user 106. The adaptive timing engine 102 may carry out such allocation iteratively after each of the slide advancements so that the timing signals consistently adapt to the time usage of the user 106 with respect to each slide of the presentation.

The adaptive timing engine 102 may use a feedback device 110 to provide the timing signals. In various embodiments, the adaptive timing engine 102 may use a communication link 112 to communicate with the feedback device 110. The communication link 112 may be implemented using various wireless communication interface technology (e g, infrared, cellular, Wi-Fi, Ultrawideband, Bluetooth, and/or the like). Alternatively or concurrently, the communication link 112 may also be implemented using various wired communication technology, such as LAN Ethernet, WAN Ethernet, a universal serial bus (USB), a high speed serial bus, and/or the like.

The feedback device 110 may include one or more feedback generators 114. The feedback generators 114 may include software and/or hardware that convert the timing signals into visual aural, speech, and/or haptic feedbacks. For instance, the haptic feedbacks may be in the form of vibrations. Other haptic feedbacks may include changes in a physical size, a shape, a temperature, compressibility, a resistance, and/or flexibility of at least a portion of the feedback device 110 to communicate the timing signals. In various embodiments, the feedback device 110 may passively or actively provide the feedback. In passive mode, the feedback device 110 may provide a feedback when the user 106 queries the feedback device 110 for a timing signal. In active mode, the feedback device 110 may periodically provide feedbacks to the user 106.

The timing signals provided by the adaptive timing engine 102 may enable the user 106 to advance through the sections of a presentation in a timely fashion while still maintain a degree of freedom with respect to the actual pace for presenting each section. For example, as shown in FIG. 1, a presentation 116 may include slides 118(1), 118(2) and 118(3), in which each slide is allocated an equal amount of presentation time. In a first scenario 120, the adaptive timing engine 102 may provide a first timing signal that triggers the user 106 to advance from the slide 118(1) to the slide 118(2) at the end of an allocated time interval 122 for slide 118(1). Likewise, the adaptive timing engine 102 may provide a second timing signal that triggers the user 106 to advance from the slide 118(2) to the slide 118(3) at the end of an allocated time interval 124. The user 106 then spends an allocated time interval 126 covering the slide 118(3). Accordingly, the user 106 may complete the presentation 116 while spending an equal amount of time covering each slide.

In a second scenario 128, the user 106 may overrun a timing signal provided by the adaptive timing engine 102 and spend the time interval 130 covering the slide 118(1). The time interval 130 may be longer than an equally allocated time interval, i.e., by a third of the overall target presentation duration. In such an instance, the adaptive timing engine 102 may dynamically reallocate the remaining time equally between the slides 118(2) and 118(3) as time intervals 132 and 134 when the user 106 advances to the slide 118(2). Accordingly, assuming that the user 106 heeds the timing signal provided by the adaptive timing engine 102 to indicate the end of the time interval 132 for the slide 118(2), the user 106 may complete the presentation by spending the time interval 134 covering the slide 118(3).

In a third scenario 136, the user 106 may advance from the slide 118(1) to the slide 118(2) prior to the adaptive timing engine 102 providing a timing signal that indicates that the evenly allocated time interval 122 has ended. This results in an abridged time interval 138 for the coverage of the slide 118(1). In such an instance, the adaptive timing engine 102 may dynamically reallocate the remaining time equally between the slides 118(20 and 118(3) as time intervals 140 and 142 when the user 106 advances to the slide 118(2). Accordingly, assuming that the user 106 heeds the timing signal provided by the adaptive timing engine 102 to indicate the end of the time interval 140 for the slide 118(2), the user 106 may complete the presentation by spending the time interval 142 covering the slide 118(3).

The temporal reallocation of timing signals by the adaptive timing engine 102 is illustrated above with respect to the example presentation 116. However, the adaptive timing engine 102 is capable of more sophisticated temporal reallocation of timing signals and timing signal provision. Further, while the timing signals are discussed in FIG. 1 with respect to slides in a slide deck, the adaptive timing engine 102 is also capable of providing timing signals with respect to other demarcations of sections (e.g., frames, topics, chapters, etc.). For example, a section may include multiple slides that cover the same topic. In another example, a section may be a portion of a slide rather than an entire slide. Additionally, the adaptive timing engine 102 is capable of functioning independently of the presentation application 104. For example, in the case of an informal discussion, the adaptive timing engine 102 may be configured to provide timing signals with respect to the number of topics to be discussed, the number of speakers involved in the discussion, etc. In this way, the adaptive timing engine 102 may ensure that each topic is covered in the discussion or that each speaker is allocated a turn in the discussion.

### Example Components

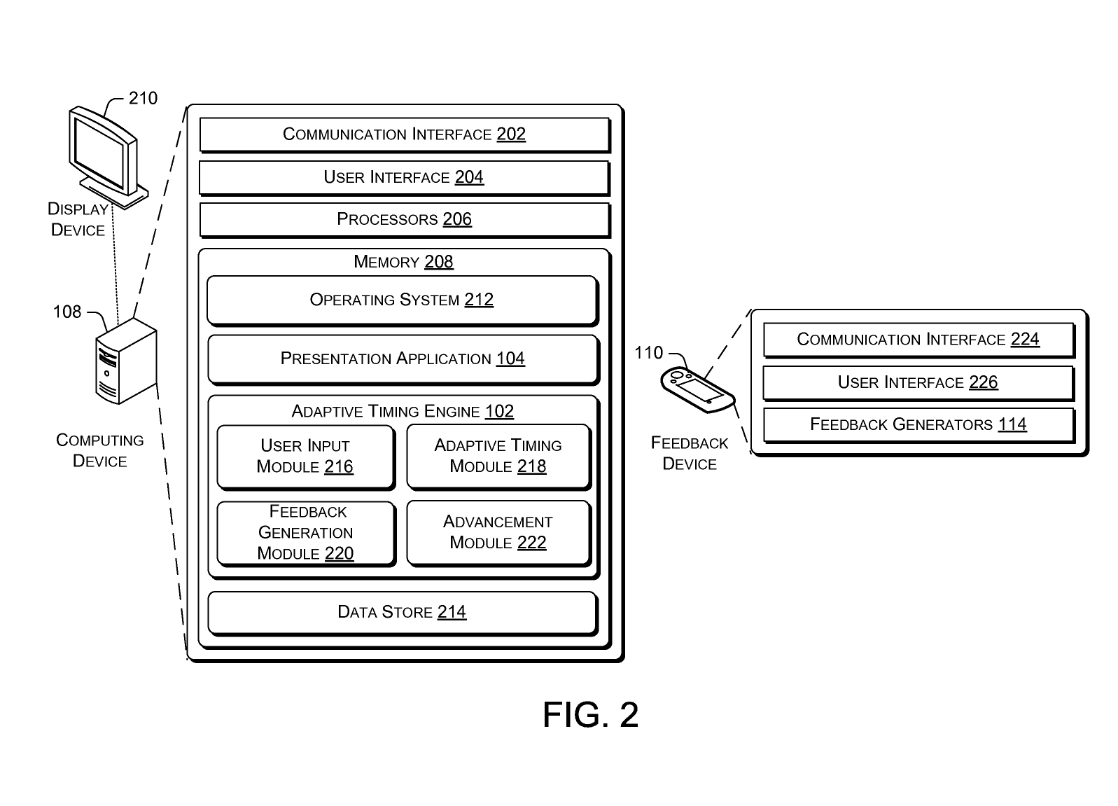

FIG. 2 is an illustrative diagram that shows example components of an adaptive timing engine 102 that provides timing support, as well as example components of a feedback device 110 that provides feedback signals. As described above, the adaptive timing engine 102 may be implemented by the computing device 108.

The computing device 108 may include a communication interface 202, user interface 204, one or more processors 206, and/or memory 208. The communication interface 202 may include wireless and/or wireless communication interface components that enable the computing device 108 to transmit and receive data via a network or a communication link. In various embodiments, the wireless interface component may include, but is not limited to cellular, Wi-Fi, Ultra-wideband (UWB), Bluetooth, satellite transmissions, and/or so forth. The wired interface component may include a direct input/output (I/O) interface, such as an Ethernet interface, a serial interface, a Universal Serial Bus (USB) interface, and/or so forth. As such, the computing device 108 may have network capabilities. For example, the computing device 108 may exchange data with other electronic devices (e.g., laptops computers, servers, feedback devices, etc.) via one or more networks, such as the Internet.

The user interface 204 may include a data output device (e.g., visual display, audio speakers, haptic display), and one or more data input devices. For example, the user interface 204 may include a display device 210. The data input devices may include, but are not limited to, combinations of one or more of keypads, keyboards, mouse devices, touch screens that accept gestures, microphones, voice or speech recognition devices, and any other suitable devices or other electronic/software selection methods.

The presentation application 104 may display a presentation, such as the presentation 116, on the display device 210. For example, the presentation application 104 may be a slideshow application that enables the user 106 to create, rehearse, and/or deliver a presentation using a deck of slides that are shown on the display device 210. Each of the slides in the slide deck may include graphs, texts, and/or multimedia content that pertain to one or more subject matter.

The memory 208 may be implemented using computer-readable media, such as computer storage media. Computer-readable media includes, at least, two types of computer-readable media, namely computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium that may be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

The memory 208 of the computing device 108 may implement an operating system 212, the presentation application 104, the adaptive timing engine 102, and the data store 214. The operating system 212 may include components that enable the computing device 108 to receive data via various inputs (e.g., user controls, network interfaces, and/or memory devices), and process the data using the processors 206 to generate output. The operating system 212 may further include one or more components that present the output (e.g., display an image on an electronic display, store data in memory, transmit data to another electronic device, etc.). The operating system 212 may enable a user to interact with the presentation application 104 and the adaptive timing engine 102 using the user interface 204. Additionally, the operating system 212 may include other components that perform various other functions generally associated with an operating system. The adaptive timing engine 102 may include a user input module 216, an adaptive timing module 218, and a feedback generation module 220.

The user input module 216 may receive user inputs to the adaptive timing engine 102. The user inputs may include parameters such as a target time duration for a presentation, a number of sections (e.g., slide deck slides) included in the presentation, specific time durations for the sections in the presentation, one or more preferred types of feedback to be used to convey timing signals for the presentation (e.g., visual, aural, speech, haptic, etc.), as well as updates to such parameters. The user inputs may also specify parameters such as a frequency, a format, a pattern, and/or temporal placement of the timing signals. For example, the user input may specify that for the end of an allocated time interval, the user 106 desires to receive a first feedback 20 seconds prior to the end of the time interval, a second feedback at the end of the time interval, and a third feedback 20 second following the end of the time interval. In various embodiments, the user input module 216 may receive one or more of such inputs during the creation of the presentation, rehearse of the presentation, or delivery of the presentation. The user input module 216 may also track user inputs to the presentation application 104 that cause advancements to remaining sections of a presentation or an end of the presentation. In turn, the user input module 216 may feed the user inputs to the adaptive timing module 218.

The adaptive timing module 218 may determine a presentation time interval for each of the sections in a presentation. In some embodiments, the adaptive timing module 218 may obtain a presentation time interval for each section by dividing the target time duration of the presentation by the number of sections. However, in other embodiments, the adaptive timing module 218 may obtain a presentation time interval for each of the sections based on time durations specified by user input. For example, the user 106 may specify that a time interval for a first slide of a slide deck is two minutes, a time interval for a second slide of the slide deck is one minute, a time interval for a third slide of the slide deck is 45 seconds, and so forth. The user may specify the time intervals using time values (e.g., a number of seconds, minutes, etc.) or using percentages of the target time duration. In various embodiments, the user 106 may use a graphical user interface provided by the user input module 216 to specify or adjust the time intervals assigned to the sections of the presentation.

In alternative embodiments, the adaptive timing module 218 may use a combination of the above to arrive at an initial time interval for each slide. In at least one embodiment, the adaptive timing module 218 may assign user specified time intervals to one or more of the sections, while equally distributing the remaining time to the remainder sections. For example, a user input may specify that a target time duration of a presentation is to be seven minutes, in which a first slide of a slide deck is to have a time interval of three minutes. However, the user input does not specify the time intervals for the remaining two slides of the slide deck. In such an example, the adaptive timing module 218 may divide the remaining four minutes equally between the two remaining slides, such that each remaining slide receives a time interval of two minutes.

In another example, a user input may specify that a target time duration of a presentation is to be ten minutes, in which a first slide of a slide deck is to have a time interval that is 40% of the target time duration. However, the user input does not specify the time intervals for the remaining three slides in the slide deck. In such an example, the adaptive timing module 218 may divide the remaining 60% of the target time duration equally between the three remaining slides, such that each remaining slide receives a time interval of two minutes.

In additional embodiments, the adaptive timing module 218 may track the user inputs received by the user input module 216 as the user 106 uses the presentation application 104 to rehearse the presentation. The user inputs may be in the form of user initiated advancements to subsequent slides in a slide deck. Thus, by monitoring the elapsed time between advancements, the adaptive timing module 218 may determine the target time duration of the presentation and the time interval for each section of the presentation. In still embodiments, the adaptive timing module 218 may use machine learning techniques. The machine learning techniques may enable the adaptive timing module 218 to infer a time interval to allocate to each of the slides based on the amount of text, images, notes, and/or embedded multimedia content in each slide. For example, the adaptive timing module 218 may use machine learning to analyze the content of each slide, and allocate similar time intervals to slides that have similar amounts and/or types of content. In another example, the adaptive timing module 218 may project a user allocated time interval for a slide to another slide that has similar amounts and/or types of content. In some instances, the user 106 may use a graphical user interface provided by the user input module 216 to specify or adjust the time intervals assigned to the sections of the presentation by the adaptive timing module 218 using machine learning techniques.

The adaptive timing module 218 may perform the determinations of timing intervals for sections of a presentation during the creation of the presentation, rehearsal of the presentation, or delivery of the presentation. For example, as the user 106 goes through an iterative process of planning a presentation, rehearsing the presentation, comparing rehearsal time to presentation time for the presentation, and updating the presentation plan, the user 106 may input time interval changes into the user input module 216. The designated target time duration and the time interval for each section of a presentation, such as the presentation 116, may be stored as metadata for the presentation.

In some scenarios, the adaptive timing module 218 may receive a user input that updates the target time duration for a presentation prior to deliver the presentation. For example, the user 106 may update the target time duration in response to a direction to lengthen the presentation shortly before starting the presentation. In such scenarios, the adaptive timing module 218 may scale the time intervals for the sections in the presentation to distribute the increase in the target time duration based on current time interval proportions of the sections. For example, if the target time duration for a slide deck presentation is increased by 10%, then the time interval assigned to each slide in the slide deck is increased by 10%, regardless of whether such slides have identical or different assigned time intervals. Conversely, the adaptive timing module 218 may also scale the time intervals proportionally based on any decrease in the target time duration in an opposite fashion.

In other scenarios, the adaptive timing module 218 may receive a user input that updates the target time duration for a presentation while delivering the presentation. In these scenarios, the adaptive timing module 218 may distribute an increase or a decrease in the target time duration equally to the sections that have not yet been presented. Alternatively, the adaptive timing module 218 may scale the time intervals for the sections that have not yet been presented to distribute an increase in the target time duration based on current time interval proportions of the sections that have not yet been presented.

For example, the target time duration for a slide deck presentation may be increased by 90 seconds, and there may be three slides remaining in the slide deck to that have not yet been presented. The first slide of the three slides originally has an allocated time interval of 10 seconds, a second slide originally has an allocated time interval of 20 seconds, and a third slide originally has an allocated time interval of 30 seconds. In such an example, the adaptive timing module 218 may distribute the additional 90 seconds proportionally as 10*90/(10+20+30), 20*90/(10+20+30), and 30*90/(10+20+30), respective, to the three remaining slides. Such a distribution may provide 25 seconds of adjusted allocated time for the first remaining slide, 50 seconds of adjusted allocated time for the second remaining slide, and 75 seconds of adjusted allocated time for the third remaining slide. Conversely, the adaptive timing module 218 may also scale the time intervals proportionally based on any decrease in the target time duration in an opposite fashion.

The adaptive timing module 218 may also dynamically adjust the time intervals that are assigned to each of the sections during the delivery of a presentation. The adaptive timing module 218 may use a timer to track an actual amount of time that the presentation application 104 dwelled on a section of the presentation by tracking the time difference between when an initial user input caused the presentation application 104 to advance to the section and when another user input caused the presentation application 104 to advance to a subsequent section or reach an end of the presentation. Accordingly, the adaptive timing module 218 may detect that user inputs indicate that the user 106 did not use up all of the allocate time interval for a section. As such, the adaptive timing module 218 may scale the time intervals for the sections that have not yet been presented to distribute a remaining portion of the allocated time interval based on current time interval proportions of the sections that have not yet been presented. In cases in which user inputs indicate that the user 106 skipped a slide, the adaptive timing module 218 may function in a similar manner to distribute the entire allocated time interval for the skipped slide.

Conversely, the adaptive timing module 218 may detect that user inputs indicate that the user 106 exceeded the allocated time interval for a section by a particular length of time. As such, the adaptive timing module 218 may scale the time intervals for the sections that have not yet been presented to decrease the allocated time interval of each such section based on current time interval proportions of the sections. The total amount of time that is decreased by the adaptive timing module 218 equals the particular length of time.

The adaptive timing module 218 may also deal with a situation in which user inputs indicate that the user 106 has skipped back to a previously presented section. For example, the user 106 may desire to go over the content of a previously presented slide for clarification purposes. In one configuration, the adaptive timing module 218 may treat the visitation of the previously presented section as a repeated advance to the previously presented section for a repeated coverage of the section. Accordingly, the adaptive timing module 218 may decrease the allocated time intervals of the un-presented sections by the time interval allocated to the section being repeated. The decrease may be implemented based on a current time interval proportions of the sections. For example, if the previously presented section has an allocated time interval of two minutes, then the adaptive timing module 218 may decrease the allocated time intervals of the un-presented sections by two minutes. In some instances, the user 106 may skip over one or more intermediate sections in order to revisit a particular slide, such skipping may be ignored by the adaptive timing module 218.

In another configuration, the adaptive timing module 218 may treat any time spent on repeating the presentation of the previously presented section as time that is added to any previously spent time for the section. Accordingly, if the user 106 previously did not spend the entire allocated time interval, the adaptive timing module 218 may allow the user 106 to spend the remainder of the allocated time interval prior to making further adjustments to the time intervals of the remaining un-presented sections. The adaptive timing module 218 may use one of these configurations as a default configuration based on user input received by the user input module 216. Further, the configuration adopted by the adaptive timing module 218 may be changed based on additional user input.

In some embodiments, the adaptive timing module 218 may adjust time intervals for sections that are topics shown within each slide of a slide deck presentation. In such embodiments, the topics listed in a single slide may be ordered in a hierarchical manner. For example, the topics may be organized according to their relative importance, in chronological order, and/or by one or more other organization schemes. Accordingly, the adaptive timing module 218 may be configured to allocate time intervals to each topic within a slide, as well as adaptively modify one or more of such time intervals based on changes to a target time duration for the entire slide deck, actual time spent discussing each topic, and/or skipping or revisiting previously discussed topics. Such time intervals and time signals may enable the user 106 to cover the topics in a slide, or at least one or more topics that are highest in the hierarchy of the slide. Furthermore, in additional embodiments, such allocation and adaptation of the time intervals for the intra-section topics may be combined with the allocation and adaptation of time intervals for an entire presentation.

The feedback generation module 220 may generate timing signals with respect to the ends of allocated time intervals. The feedback generation module 220 may generate such timing signals based on user inputs that specify parameters such as frequencies, formats, patterns, and/or temporal placements of the timing signals. Further, based on the type of feedback designated via user input, the feedback generation module 220 may send the timing signals to one or more relevant feedback generators 114 to provide the appropriate feedback.

The advancement module 222 may cause the presentation application 104 to advance to a subsequent section of a presentation when a threshold time interval for a previous section is reached. The threshold time interval may be established based on user inputs to the user input module 216. In various embodiments, the threshold time interval for a section may be any duration that is longer than an allocated time interval for the section. For example, the threshold time interval for a slide in a slide deck presentation may be set at twice the length of the existing allocation time interval. In such an example, the advancement module 222 may cause the presentation application 104 to automatically advance to a subsequent slide when the threshold time interval is reached. In this way, the adaptive timing engine 102 may force the user 106 to maintain a presentation pace that enables the user 106 to finish the presentation on time.

Alternatively or concurrently, the advancement module 222 may also use threshold time intervals that are established for topics in a section based on additional user inputs to the user input module 216. As such, the advancement module 222 may force the user 106 to move to a subsequent topic by causing the presentation application 104 to highlight text, expand an image, or otherwise placing more emphasis on the content in a section that corresponds to the subsequent topic. The advancement module 222 may also emphasize the content in a section that corresponds to the subsequent topic by deemphasize the content related to other topics in the section. Such de-emphasis may be achieved by reducing the contrast, graying out, shrinking, or otherwise rendering the content more difficult or impossible to view. In additional embodiments, the advancement module 222 may also use the threshold time intervals to cause the presentation application 104 to auto scroll notes in the sections that may are otherwise manually scrolled.

The data store 214 may store the presentations, such as the presentation 116. Further, settings for a presentation, such as the designated target time duration, time interval for each section of a presentation, the type and nature of timing signals, the type and nature of feedback, etc., may be stored in the data store 214 as metadata for the presentation. Additionally, the data store 214 may store other user inputs for the presentation, such as the various settings used by the modules of the adaptive timing engine 102 in the data store 214.

The feedback device 110 may include a communication interface 224, a user interface 226, and one or more feedback generators 114. The communication interface 224 may include wireless and/or wireless communication interface components that enable the computing device 108 to transmit and receive data via a network or a communication link. In various embodiments, the wireless interface component may include, but is not limited to cellular, Wi-Fi, Ultra-wideband (UWB), Bluetooth, and/or so forth. The wired interface component may include a direct input/output (I/O) interface, such as an Ethernet interface, a serial interface, a Universal Serial Bus (USB) interface, and/or so forth. As such, the communication interface 224 may enable the feedback device 110 to exchange data with the computing device 108.

The user interface 226 may include a data output device (e.g., visual display, audio speakers), and one or more data input devices. The data input devices may include, but are not limited to, combinations of one or more of keypads, keyboards, mouse devices, display screens, touch screens that accept gestures, microphones, voice or speech recognition devices, and any other suitable devices or other electronic/software selection methods. The user 106 may use the user interface 226 to interact with the adaptive timing engine 102 and the presentation application 104. For example, the user interface 226 may be used to command the presentation application 104 to advance or revisit sections in a presentation. In another example, the user interface 226 may be used to provide user inputs to the user input module 216 of the adaptive timing engine 102.

The feedback generators 114 may include software and/or hardware that convert the timing signals from the feedback generation module 220 into visual, aural, speech, and/or haptic feedbacks. For example, the feedback generators 114 may include a sound generator, a speech synthesizer, a vibrator, a buzzer, a graphics generator, an air compressor, a heating element, a cooling element, mechanical elements, and/or other elements. The feedback provided may fall into several design dimensions. Feedback frequency may be discrete, periodic, or continuous. In other words, feedback may be provided as discrete events (e.g., a vibration that signals that there are three minutes remaining). Periodic feedbacks may be in the form of vibrations that count the number of minutes remaining. Continuous feedbacks may be feedbacks that continuously change, such as a smoothly extending progress bar.

The feedbacks may be additive, subtractive, symbolic, unipolar or bipolar. For example, feedback that shows that time is counting up may be additive. Conversely, feedback that shows time is counting down to an end of a time interval may be subtractive. Uniploar feedback may show the proportions of the allocated time interval that is used up or remaining, while bipolar feedback may extend the proportional representation into degrees of overage above the allocated time interval.

For example, the feedback for a section of a presentation may begin at 100% under-time, i.e., there is 100% of the allocated time interval to go. As the elapsed time progresses towards the end of the allocated time interval, the feedback may signal 0% under-time, i.e., exactly on-time according to the allocated time interval. If the presentation is not advanced to the next section at this point, the feedback may represent the percentage of the allocated time interval that has been exceeded. In some instances, the amount of overrun may be limited to no more than 100% of the allocated time interval before feedback stops. However, in other instances, the amount of overrun for the providing feedback may extend indefinitely.

The feedback provided by the feedback generators 114 may take many forms. For instance, the feedback may be in the form of a progress bar that starts from 100% under-time, continues to 0% under time, and then proceeds to 100% over time.

In another instance, the feedback may be in the form of a continuous visual color value. For example, an indicator shown on the display device 210 with a presentation may communicate a bipolar scale by smoothly animating between three colors, in which one of the colors represents 100% under-time, a second color represents on-time (i.e., the entire allocated time is used up), and a third color represents 100% over time. In an additional instance, the feedback may be in the form of a continuous visual scale. For example, an indicator shown on the display device 210 with a presentation may be a progress bar that smoothly fills from 0% to 100% for a section, in which 100% indicates that the entire allocated time is used up. The progress bar may further fill to a further percentage (e.g., 200%) to indicate that the time devoted to the section is becoming more and more over a time allocation. In such instances, the feedback generators 114 may reside on the computing device 108 rather than the feedback device 110.

The feedback may be further in the form of discrete aural speech values. For example, an earpiece of the feedback device 110 may deliver synthesized speech at predetermined points in the allocated time interval for a section, such as halfway through the allocated time interval for a section, 20% to the end of the allocated time interval, 10% over the allocated time interval, etc.

In another instance, feedback in the form of periodic aural sound values may be implemented by the feedback device 110. For example, an ear piece of the feedback device 110 may deliver sound patterns at proportional points in the allocated time interval for a section, such as at every 20% of the allocated time interval, in which each percentage value is represented by a reducing number of pulses (e.g., xxxxx, xxxx, xxx, xx, x). Further, when the allocated time interval is exceeded, the overrun percentage values may be expressed by extending the duration of the final lone pulse (e.g., x---x, x------x, x---------x), in a linear or exponential manner.

Discrete haptic vibrations may also be implemented by the feedback device 110. For example, the feedback device 110 may be a wearable haptic device that delivers symbolic vibration patterns at predetermined points in the allocated time interval for a section, such as 10% to go to the end of the allocated time interval, at the end of the allocated time interval, and 10% over the allocated time interval, etc.

Alternatively, the feedback device 110 may also implement periodic haptic vibrations. For example, the feedback device 110 may be a wearable haptic device that delivers vibration patterns at proportional points in the allocated time interval for a section, such as at every 20% of the allocated time interval, in which each percentage value is represented by a reducing number of pulses (e.g., xxxxx, xxxx, xxx, xx, x). Further, when the allocated time interval is exceeded, the overrun percentage values may be expressed by extending the duration of the final lone pulse (e.g., x---x, x------x, x---------x), in a linear or exponential manner.

In a further instance, the feedback may be in the form of a periodic haptic vibration scale. The feedback device 110 may be a wearable haptic device that delivers vibration patterns at proportional points in the allocated time interval for a section, in which time between vibrations represent a scale. For example, the vibrations may be in the form of xxoooox, xoxooox, xooxoox, xoooxox, in which “x” represents vibration and “o” represents lack of vibration. Further, when the allocated time interval is exceeded, the overrun proportional points may be represented by extending the duration of the final vibration or by adding extra vibrations to the pattern. However, in order to avoid confusion, the rest intervals between patterns of the proportional points may be configured to exceed the interval between a first pulse and a final pulse of each pattern. In another example, the vibrations may have reduced intervals between a fixed number of pulses in correspondence with proportional points in an allocated time interval, e.g., xooooooooxoooooooox, xooooxoooox, xooxoox, xoxox, xxx, in which“x” represents vibration and “o” represents lack of vibration.

In some embodiments, multiple feedback types may be implemented in parallel by the feedback device 110 and/or the computing device 108. Haptic feedbacks through wearable, handheld, or touch-based haptic devices do not generally compete for the visual attention or aural attention of the user 106. For wearable approaches to haptic stimulation, vibration may be extended to multiple vibration actuators arranged in lines, grids, or at different bodily locations. Haptic stimulation patterns may thus have spatial, perceptual, and/or temporal characteristics, e.g., communication through the length or direction of a haptically-induced stroke path. Handheld approaches may include automatically manipulating the physical size, the shape, the temperature, the compressibility, or the flexibility of a physical object to communicate progress through an allocated time interval. For example, a portion of the feedback device 110 (e.g., a button) may become proportionally easier or harder to hold down as time in an allocated time interval goes by. In another, a portion of the feedback device 110 (e.g., a button) may become easier or more difficult to press in proportional to the passage of the allocated time interval.

In some embodiments, feedbacks may be provided passively rather than actively, i.e., a feedback may be provided in response to an action (e.g., clicking a key) by the user 106. Thus, the user 106 may be saved from experiencing potentially disruptive distractions. For approaches involving the use of a touch surface to change sections (e.g., by tapping or swiping with a finger), the surface itself may be actuated to provide “key click” feedback. Alternatively or concurrently, the touch surface may communicate the passage of time with respect to an allocated time interval by changing the degree of surface friction, e.g., the perceived texture, when the user 106 drags one or more fingers across the surface. In further embodiments, the feedback device 110 may be configured so that passive feedback is provided while the passage of time is approaching the end of a time interval, while active feedback (e.g., vibrations at predetermined time points) may be provided for the passage of time beyond the allocated time interval, or vice versa.

The above feedback schemes operate at the level of sections in a presentation. Accordingly, the feedback schemes give the user 106 local information (e.g., how close am I to the target transition point for this section?), which may help the user 106 make a local decision (e.g., when do I advance to the next section?). However, the user 106 may also wish to know the overall deviation from the target time duration for an entire presentation as well as how to correct the deviation. One way to achieve this may involve setting a “comfort zone” for presentation completion times, expressed as minimum, ideal, and maximum talk times, or as a target time duration with the maximum allowed overrun and under run time. Thus, as the user 106 moves through the presentation, the adaptive timing module 218 may compare the actual presentation time to that point to calculate an absolute time deviation. Accordingly, the feedback generators 114 may communicate the absolute time deviation directly as a number or encoded in a similar fashion to the bipolar section timing feedback. For example, if the absolute time deviation is an overrun, feedbacks may represent the overrun as proportions of the maximum overrun time. Conversely, if the absolute time deviation is an under run, feedbacks may represent the under run as proportion of the maximum under run time. The bipolar presentation time feedbacks may be communicated in a different modality as the section-level feedbacks.

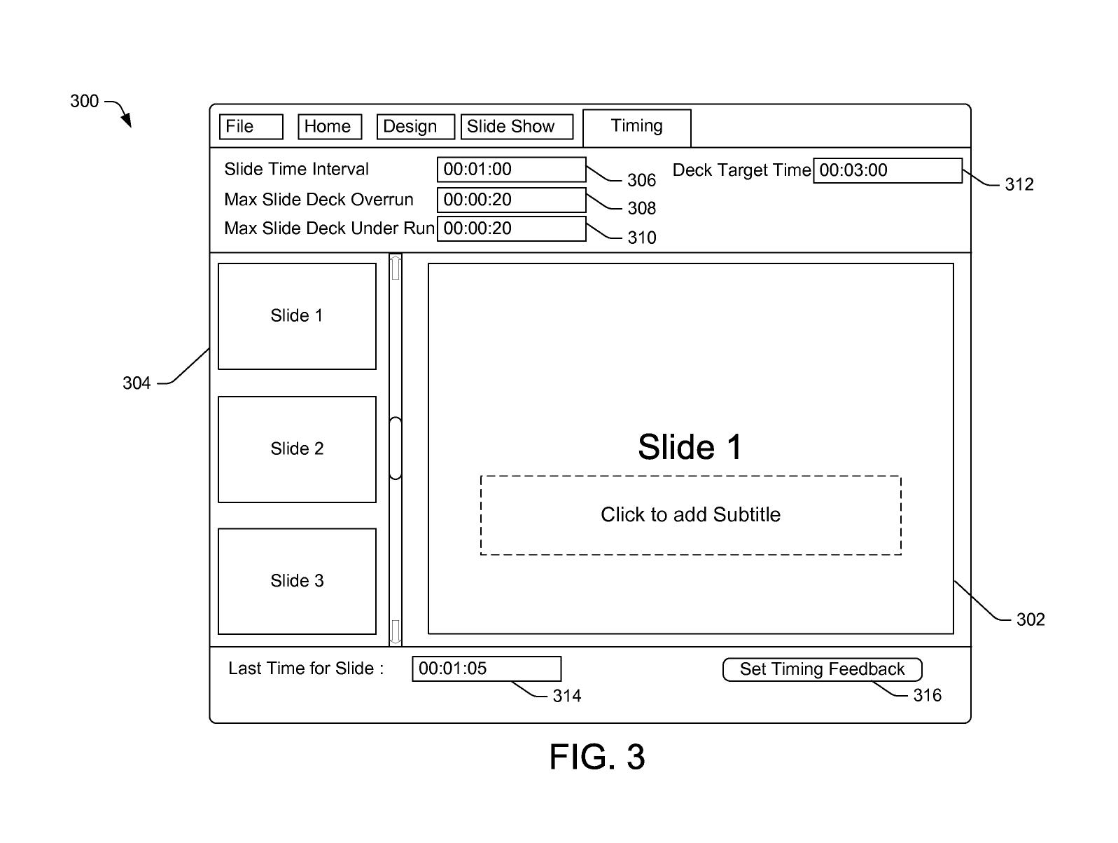

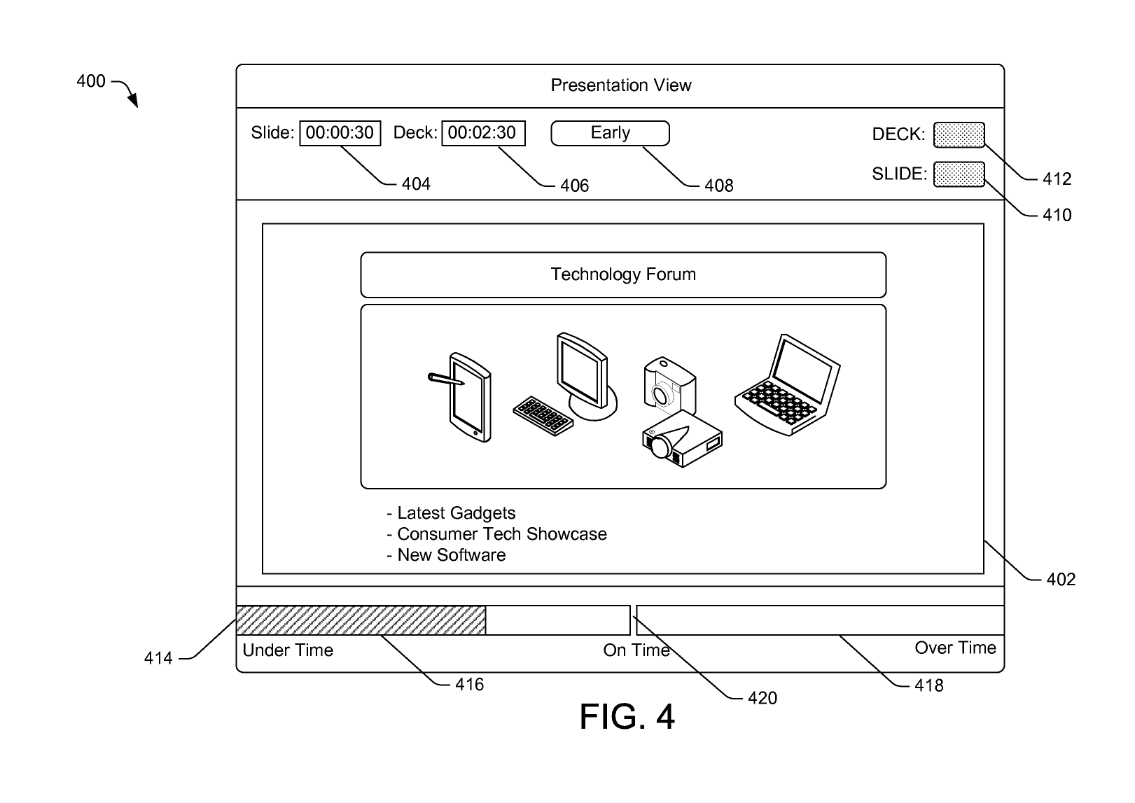

While some of the functionalities of the adaptive timing engine 102 and the feedback generators 114 have been discussed above in FIG. 2, additional functionalities are further discussed with respect to the illustrative user interfaces in FIGS. 3 and 4.

### Example User Interfaces

FIG. 3 shows an illustrative user interface page 300 for setting presentation timing intervals of multiple slides in a slideshow. The user interface page 300 may be one of the user interface pages displayed by the presentation application 104 in cooperation with the adaptive timing engine 102. The user interface page 300 may include a slide edit portion 302, a slide selection portion 304, a slide time interval portion 306, a maximum slide overrun portion 308, a maximum under run portion 310, and a deck target time portion 312.

The slide edit portion 302 may enable the user 106 to add, modify, or delete content from individual slides in a slide deck. The content may include texts, images, audio snippets, multimedia clips, and/or so forth. The slide selection portion 304 may enable the user 106 to add additional slides or delete existing slides from the slide deck. Further, when the user selects a slide from the slide edit portion 302, the user 106 may view the slide time interval, the maximum slide overrun time, and the maximum slide under run time for the selected slide. In this way, the user 106 may configure the number of sections or topics to be discussed in the slide deck, as well as control the duration of a presentation that is based on the slide deck.

The slide time interval portion 306 may display a slide time interval for each slide. In some embodiments, the adaptive timing module 218 may automatically assign a slide time interval. For example, the adaptive timing module 218 may be configured to assign the slide time intervals by dividing a total slide deck presentation target time by the number of slides in the slide deck. In another example, the time interval assigned by the adaptive timing module 218 to each slide may be based on a last rehearsed slide time that was tracked by the adaptive timing module 218. The last rehearsed slide time may be displayed in the last time portion 314. In other embodiments, the user 106 may input time values into the slide time interval portion 306 to manually configure the time duration for covering a slide. The manual input of a time value for a slide may cause the adaptive timing module 218 to automatically distribute any resultant increase or decrease in the allocated time evenly across the time intervals for the other slides in the slide deck.

The maximum slide deck overrun portion 308 may determine an amount of maximum overrun time for discussing the entire slide deck. Once configured, the amount of maximum overrun time for a slide deck may be automatically allocated by the adaptive timing module 318 equally or proportionally to the slides in the slide deck. Alternatively, the amount of maximum overrun time may be manually configured by the user 106 with user input into the maximum slide deck overrun portion 308. The amount of maximum overrun time may affect the provision of timing signals and/or forced section advancements by the adaptive timing engine 102.

The maximum slide deck under run portion 310 may determine an amount of maximum under run time for covering a slide deck. Once configured, the amount of maximum under run time for a slide may be automatically allocated by the adaptive timing module 318 equally or proportionally to the slides in the slide deck. Alternatively, the amount of maximum under run time may be manually configured by the user 106 with user input into the maximum slide deck under run portion 310. The amount of maximum under run time may affect the provision of timing signals by the adaptive timing engine 102.

The deck target time portion 312 may show a total slide deck presentation target time. In some embodiments, the total target time may be manually inputted by the user 106 into the deck target time portion 312. In other embodiments, the adaptive timing module 318 may automatically calculate the total target time as a total of the slide timer intervals assigned to the slides in a slide deck.

The set timing feedback option 316 may enable the user 106 to set parameters for the timing feedbacks for each slide. Accordingly, the timing feedbacks may be discrete, periodic, or continuous, additive, subtractive, symbolic, unipolar and/or bipolar. Further, the feedbacks may be visual, aural, speech, and/or haptic. For instance, the haptic feedbacks may be in the form of vibrations, changes in a physical size, a shape, a temperature, compressibility, a resistance, and/or flexibility that are generated by the feedback device 110.

FIG. 4 shows an illustrative user interface page 400 for providing timing signals during the presentation of a slideshow. The user interface page 400 may include a slide window 402, a slide time portion 404, a deck time portion 406, a status indicator 408, a color slide indicator 410, and a color deck indicator 412. The user interface page 400 may further include a progress bar 414. The user interface page 400 may be one of the user interface pages displayed by the presentation application 104 in cooperation with the adaptive timing engine 102. In various embodiments, the user interface page 400 may be displayed to the user 106 as the user 106 is delivering a presentation to an audience.

The slide window 402 may show a current slide that is being displayed to the audience. The content of the current slide may include texts, images, audio snippets, multimedia clips, and/or so forth. The slide time portion 404 may display the amount of allocated time interval that is remaining for the current slide. For example, the slide time portion 404 may display 30 seconds, indicating that there are still 30 seconds remaining for the user 106 to cover the current slide. The slide time portion 404 may display a negative number when the time spent on the coverage has exceeded the allocated time interval.

The deck time portion 406 may display the amount of target time duration that is remaining for the presentation of the entire slide deck. In this way, the user 106 may be further informed of the overall time that is remaining. The status indicator 408 may provide a text indicator of a time status with respect to the current slide shown in the slide window 402. For example, the status indicator 408 may show the status of a slide deck if the user 106 is to advance to a subsequent slide of the slide deck at the current time. For example, the status indicator 408 may show the text “early” if the time spent on the current slide has not yet reached the allocated time interval, i.e., the current status is under run. The status indicator 408 may show the text “on time” if the time spent on the current slide reached the end of the allocated time interval. The user 106 may use such a status indication to advance to the next slide in the slide deck. The status indicator 408 may show the text “late” if the time spent on the current slide has exceeded the allocated time interval, i.e., the current status is overrun.

Likewise, the color slide indicator 410 may display colors that show the time status with respect to the current slide shown in the slide window 402. For example, the color slide indicator 410 may show the color green if there is 100% of the slide time remaining. Subsequently, the color green may transition in hue gradually to yellow but not reaching yellow as the time spent on the current slide passes in the allocated time interval. The color slide indicator 410 may show the color yellow if the time spent on the current slide reached the end of the allocated time interval. The user 106 may use such a status indication to advance to the next slide in the slide deck. The color slide indicator 410 may transition in hue from yellow to red but not reaching red as the time spent on the current slide continuously exceeds the allocated time interval. The color of the color slide indicator 410 may turn completely red when the time spent on the current slide reaches 100% overrun of the allocated time interval.

Similarly, the color deck indicator 412 may display colors that show the time status with respect to the entire slide deck during the presentation of the slides in the slide deck. In various embodiments, the adaptive timing module 218 may add together the allocated time intervals for the remaining slides in the slide deck to generate a current remaining time. The adaptive timing module 218 may then compare the current remaining time to an actual remaining time until the end of the target time duration. Thus, if the current remaining time diverges from the actual remaining time by more than a maximum overrun threshold, the presentation may be considered late. Alternatively, if the current remaining time diverges from the actual remaining time by more than a maximum under run threshold, then the presentation may be considered early. Otherwise, the presentation may be considered to be within an on time threshold window.

Accordingly, the color deck indicator 412 may show the color green if at any point during the target time duration the presentation of one or more slides in the slide deck is ahead of schedule. The color deck indicator 412 may show the color yellow if at any point during the target time duration the presentation of one or more slides in the slide deck is on time. The color deck indicator 412 may show the color red if at any point during the target time duration the presentation of one or more slides in the slide deck is behind schedule. Accordingly, the color deck indicator 412 may keep the user 106 apprised of the presentation pace with respect to the entire slide deck even as the user 106 is covering each of the slides in the slide deck.

The progress bar 414 may be a bipolar scale that shows a passage of time with respect to the allocated time interval for the current slide. In some embodiments, the progress bar 414 may include an under time portion 416 and an over time portion 418. The progress bar 414 may gradually fill the under time portion 416 when the user 106 advances to the current slide to denote the passage of time. The progress bar 414 may fill the entire under time portion 416 and reach the on time mark 420 at the end of the allocated time interval. If the user 106 does not advance to a subsequent slide at this point, the progress bar 414 may continue to fill in the over time portion 418 as time further passes. The over time portion 418 may represent a predetermined time duration, such as a time length that is the same as the allocated time interval or less. Accordingly, the various indicators on the user interface page 400 may provide feedback that assists the user 106 in maintain an appropriate pace for presenting a slide deck.

### Example Processes

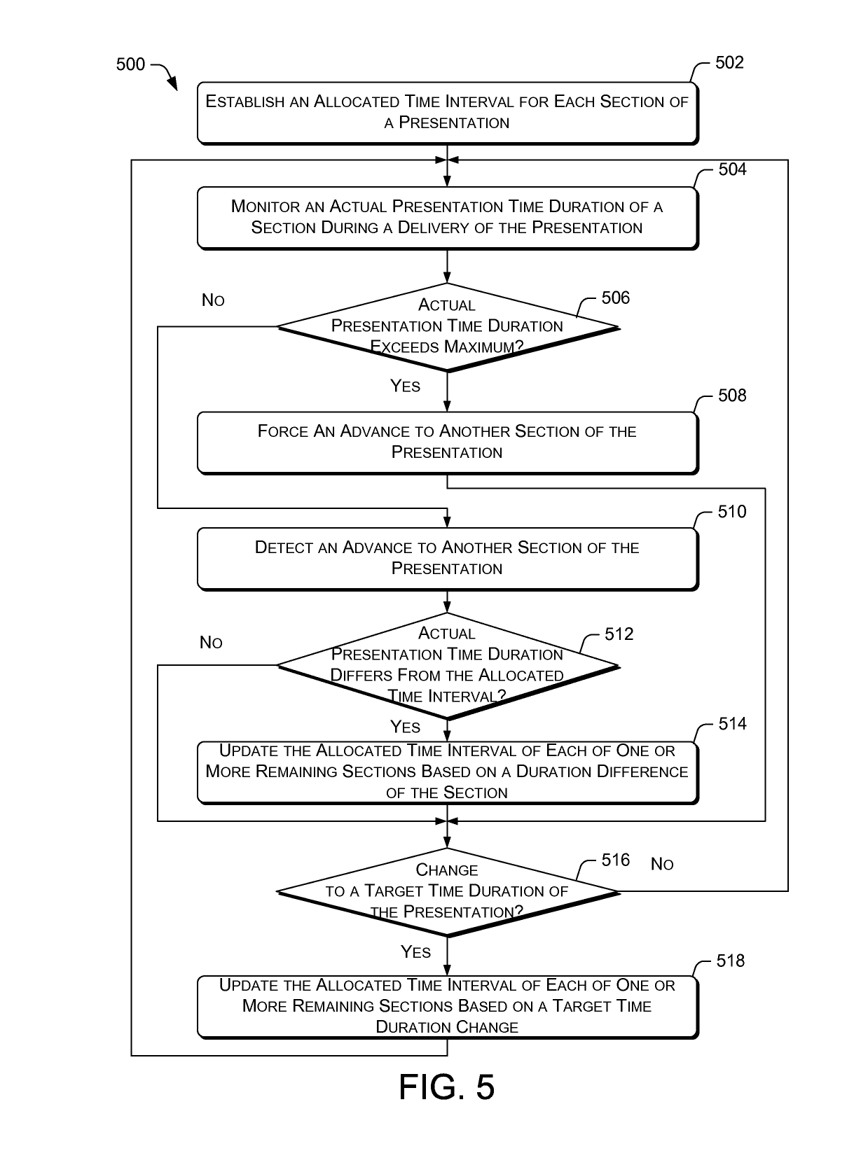

FIGS. 5-7 describe various example processes for providing timing support that adaptively changes during a delivery of a presentation. The order in which the operations are described in each example process is not intended to be construed as a limitation, and any number of the described operations may be combined in any order and/or in parallel to implement each process. Moreover, the operations in each of the FIGS. 5-7 may be implemented in hardware, software, and/or a combination thereof. In the context of software, the operations may represent computer-executable instructions that, when executed by one or more processors, cause one or more processors to perform the recited operations. The one or more processors may be included in individual computing devices or included in multiple computing devices that are part of a cloud. Generally, computer-executable instructions include routines, programs, objects, components, data structures, and so forth that cause the particular functions to be performed or particular abstract data types to be implemented. In other embodiments, the operations of each example process may be executed by a hardware logic circuit, such as a dedicated integrated circuit.

FIG. 5 is a flow diagram that illustrates an example process 500 for adaptively providing timing signals during the presentation of a slideshow. At block 502, the adaptive timing engine 102 may establish an allocated time interval for each of multiple sections of a presentation, such as the presentation 116. In some embodiments, the presentation may be a slide deck that includes sections in the form of slides. In other embodiments, the sections may be in the forms of frames, topics in a slide, or other discrete units of information. Each allocation time interval is a length of time in which the user 106 may cover the content of each section. Each of the allocated time intervals may be established based on a target time duration for the presentation.

At block 504, the adaptive timing engine 102 may monitor an actual presentation time duration for a section during a delivery of the presentation. The presentation may be delivered using the presentation application 104. The adaptive timing engine 102 may begin tracking the actual presentation time duration when the user 106 advances to the section of the presentation. Further, the adaptive timing engine 102 may end the tracking of the actual presentation time duration when the user 106 advances to another section of the presentation.

At decision block 506, the adaptive timing engine 102 may determine whether the actual presentation time duration exceeds a maximum time length. The maximum time length may be longer in time than the allocated time interval of the section. In some embodiments, the maximum time length may be proportional to the allocated time interval (e.g., 150%, 200%, etc.). Thus, if the adaptive timing engine 102 determines that the actual presentation time duration exceeds the maximum time length (“yes” at decision block 506), the process 500 may continue to block 508.

At block 508, the adaptive timing engine 102 may cause the presentation application 104 to force an advance to a subsequent section of the presentation. In this way, the adaptive timing engine 102 may keep the user 106 on track to finish the presentation by the target time duration. Subsequently, the process 500 may continue directly to decision block 516. Alternatively, if there are no remaining sections available in the presentation, the adaptive timing engine 102 may force the presentation to end. However, if the adaptive timing engine 102 determines that the actual presentation time duration does not exceed the maximum time length (“no” at decision block 506), the process 500 may continue to block 510.

At block 510, the adaptive timing engine 102 may detect an advance to a subsequent section of the presentation. The advancement may be triggered by a user input to the presentation application 104. The adaptive timing engine 102 may detect such user inputs.

At decision block 512, the adaptive timing engine 102 may determine whether the actual presentation time duration for the section differs from the allocated time interval for the section. The actual presentation time duration may be different when it under runs or overruns the allocated time interval. Accordingly, if the adaptive timing engine 102 determines that the actual presentation time duration is different from the allocated time interval for the section (“yes” at decision block 512), the process 500 may proceed to block 514.

At block 514, the adaptive timing engine 102 may update the allocated time interval of each subsequent section based on a duration difference of the section. In other words, any under runs or over runs of time for the section may be proportionally distributed to one or more remaining sections of the presentation. The proportional distribution may be based on the ratios between the lengths of the existing allocated time intervals for the remaining sections. However, if the adaptive timing engine 102 determines that the actual presentation time duration is not different from the allocated time interval for the section (“no” at decision block 512), the process 500 may proceed directly to decision block 516.

At decision block 516, the timing engine 102 may determine whether there is a change to the overall target time duration of the presentation. The target time duration may be changed based on a user input to the adaptive timing engine 102. For example, the user 106 may have decided to extend or decrease the time length of the presentation. Accordingly, if the adaptive timing engine 102 determines that there is a change to the target time duration (“yes” at decision block 516), the process 500 may continue to block 518. At block 518, the adaptive timing engine 102 may update the allocated time interval of each subsequent section based on a change in the target time duration. In other words, any increase or decrease in the target duration time of the presentation may be proportionally distributed to one or more remaining sections of the presentation. The proportional distribution may be based on the ratios between the lengths of the existing allocated time intervals for the remaining sections. Subsequently, the process 500 may loop back to block 504, at which point the adaptive timing engine 102 may monitor the actual presentation time duration of the subsequent section. However, if the adaptive timing engine 102 determines that there is no change to the target time duration (“no” at decision block 516), the process 500 may loop back to the block 504.

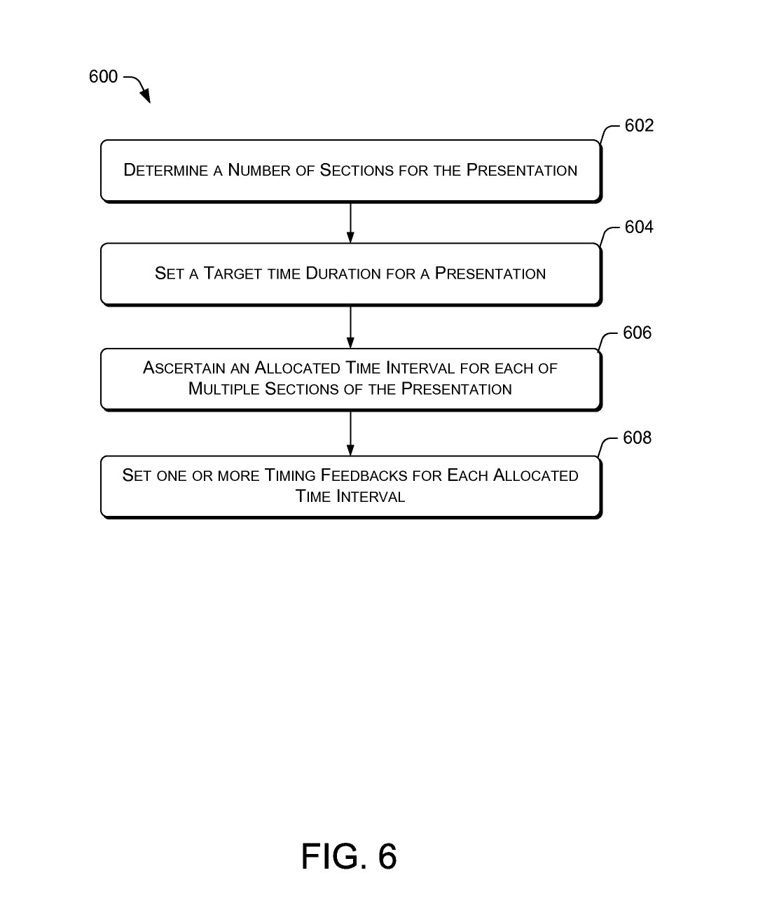

FIG. 6 is a flow diagram that illustrates an example process 600 for setting the presentation time intervals of multiple slides in a slideshow. The example process 600 may further describe block 502 of the example process 500.

At block 602, the adaptive timing engine 102 may determine a number of sections for the presentation, such as the presentation 116. The number of the sections may be determined based on the configuration of the presentation by the user 106 using the presentation application 104. The adaptive timing engine 102 may detect the user inputs that configure the presentation.

At block 604, the adaptive timing engine 102 may set a target time duration for the presentation. The target time duration may be set according to user input to the presentation application 104 that is detected by the adaptive timing engine 102. The target time duration may be obtained through a rehearsal of a delivery of the presentation by the user 106, machine learning analysis of the content in the presentation, and/or so forth.

At block 606, the adaptive timing engine 102 may ascertain an allocated time interval for each of multiple sections of the presentation. In some embodiments, the adaptive timing engine 102 may automatically calculate the allocated time interval of each section based on the target duration and the number of sections. Alternatively or concurrently, the adaptive timing engine 102 may also receive user inputs that configure the allocated time interval for each of one or more sections.

At block 608, the adaptive timing engine 102 may set one or more timing feedbacks for each allocated time interval. The adaptive timing engine 102 may set each feedback based on user inputs that determine a type, a frequency, a format, a pattern, and/or a temporal placement of the feedback. Accordingly, the timing feedbacks may be discrete, periodic, continuous, additive, subtractive, symbolic, unipolar and/or bipolar. Further, the feedbacks may be visual, aural, speech, and/or haptic. For instance, the haptic feedbacks may be in the form of vibrations, changes in physical size, shape, temperature, compressibility, resistance, and/or flexibility that are generated by the feedback device 110.

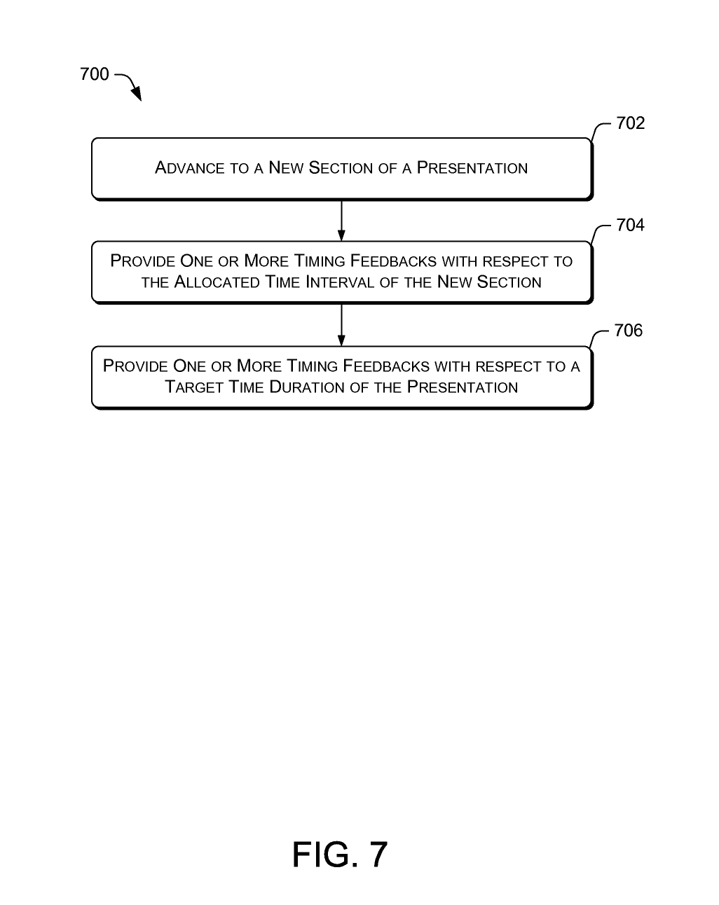

FIG. 7 is a flow diagram that illustrates an example process 700 for providing timing signals with respect to a section of the presentation and the entire presentation.

At block 702, a presentation application 104 may advance to a new section of the presentation. The presentation application 104 may perform such an advancement based on a user input from the user 106 or a trigger from the adaptive timing engine 102.

At block 704, the adaptive timing engine 102 may provide one or more timing feedback with respect to the allocated time interval for the new section. In various embodiments, the timing feedbacks may indicate whether an amount of time that the user 106 spent on the new section is less than, equal to, or over the allocated time interval for the new section. Each feedback may also communicate a temporal proximity to the end of the allocated time interval. The feedbacks may be used by the user 106 to maintain a pace that the enables the user 106 to finish the presentation at the end of a target duration time.

At block 706, the adaptive timing engine 102 may provide one or more timing feedbacks with respect to a target time duration of the presentation. The feedbacks may indicate whether the user 106 is ahead of schedule, on time, or behind schedule with respect to the target time duration. Accordingly, the one or more timing feedbacks may keep the user 106 apprised of the presentation pace with respect to the entire presentation even as the user 106 is covering each of the sections in the presentation.

The techniques for providing adaptive timing support may reduce the cognitive load on a presenter during a presentation by tracking the pace of the presentation on behalf of the presenter. Accordingly, effort on the part of the presenter to mentally compare the actual progress and the planned progress of a presentation may be eliminated. Instead, the presenter may rely on the timing signals to advance through the sections of a presentation to finish on time while still maintain a degree of flexibility with respect to the actual pace for presenting each section. As such, the presenter may be able to devote more mental concentration with respect to the content of the presentation such that the presentation becomes more natural and fluid.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

What is claimed is:

1. One or more computer-readable media storing computer-executable instructions that are executed to cause one or more processors to perform acts comprising:
establishing an allocated time interval for each of multiple sections of a presentation based on a target time duration for the presentation;
monitoring an actual presentation time duration of a section during a coverage of the section;
detecting an advance to another section of the presentation; and
updating an allocated time interval established for each of one or more remaining sections in the presentation based on a time difference between the actual presentation time duration and the allocated time interval of the section.

2. The one or more computer-readable media of claim 1, wherein the establishing includes distributing a portion of the target time duration to the section based on a number of the sections in the presentation or setting an allocated time interval for the section based on an inputted time value.

3. The one or more computer-readable media of claim 1, further comprising providing one or more timing feedbacks with respect to at least one of the allocated time interval or the target time duration during the coverage of the section.

4. The one or more computer-readable media of claim 3, wherein the providing includes providing the one or more feedbacks in response to an input or providing the one or more feedbacks periodically during the actual presentation time duration.

5. The one or more computer-readable media of claim 3, wherein the providing includes providing a visual, an aural, a speech, or a haptic feedback that signals a passage of time being within the allocated time interval of the section, reaching an end of the allocated time interval of the section, or exceeding the allocated time interval of the section.

6. The one or more computer-readable media of claim 5, wherein the visual, the aural, the speech, or the haptic feedback further indicates an amount of time to the end of the allocated time interval of the section, the end of the allocated time interval, or an amount of time that the actual presentation time duration reached or exceeded the allocated time interval of the section with at least one of a spatial characteristic, a perceptual characteristic, or a temporal characteristic.

7. The one or more computer-readable media of claim 5, wherein the haptic feedback includes at least one of a vibration, a shape change, a temperature change, a compressibility change, a resistance change, a flexibility change, or a surface friction produced by a feedback device.

8. The one or more computer-readable media of claim 1, further comprising forcing the advance to the subsequent section of the presentation during the coverage of the section when the actual presentation time duration exceeds a maximum time threshold.

9. The one or more computer-readable media of claim 1, further comprising:
receiving a change to the target time duration for the presentation during a delivery of the presentation; and
changing the allocated time interval established for each of the one or more remaining sections in the presentation based on an increase or a decrease in the target time duration.

10. The one or more computer-readable media of claim 9, wherein the changing the allocated time interval established for each of the one or more remaining sections includes distributing the increase or decrease in the target time duration proportionally to each of a plurality of remaining sections based on a ratio between allocated time intervals of the plurality of remaining sections.

11. The one or more computer-readable media of claim 1, wherein the updating the allocated time interval established for each of the one or more remaining sections includes distributing the time difference proportionally to each of a plurality of remaining sections based on a ratio between allocated time intervals of the plurality of remaining sections.

12. The one or more computer-readable media of claim 1, wherein the section of the presentation is a slide of a slide deck, a hierarchical topic in the slide, a topic in a meeting, or a frame in a plurality of frames.

13. A computer-implemented method, comprising:
establishing an allocated time interval for each of multiple sections of a presentation based on a target time duration for the presentation;
monitoring an actual presentation time duration of a section during a coverage of the section;
providing one or more timing feedbacks with respect to at least one of the allocated time interval or the target time duration during the coverage of the section, each timing feedback signaling a passage of time being within the allocated time interval of the section, reaching an end of the allocated time interval of the section, or exceeding the allocated time interval of the section;
detecting an advance to another section of the presentation; and
updating an allocated time interval established for each of one or more remaining sections in the presentation based on a time difference between the actual presentation time duration and the allocated time interval of the section.

14. The computer-implemented method of claim 13, wherein each timing feedback is a visual, an aural, a speech, or a haptic feedback that further indicates an amount of time to the end of the allocated time interval of the section, the end of the allocated time interval, or an amount of time that the actual presentation time duration exceeded the allocated time interval of the section with at least one of a spatial characteristic, a perceptual characteristic, or a temporal characteristic.

15. The computer-implemented method of claim 14, wherein the haptic feedback includes at least one of a vibration, a shape change, a temperature change, a compressibility change, a resistance change, a flexibility change, or a surface friction produced by a feedback device.

16. The computer-implemented method of claim 13, further comprising:
receiving a change to the target time duration for a delivery of the presentation; and
updating the allocated time interval of the each of the one or more remaining sections in the presentation based on an increase or a decrease in the target time duration.

17. The computer-implemented method of claim 13, wherein the monitoring includes monitoring the actual presentation time duration of the section for a discontinuous coverage of the section, and wherein the detecting includes detecting an advance to a previously discussed section of the presentation.

18. A system, comprising:
one or more processors;
a memory that includes a plurality of computer-executable components that are executable by the one or more processors, comprising:
an adaptive timing component that establishes an allocated time interval for each of multiple sections of a presentation based on a target time duration for the presentation, and monitoring an actual presentation time duration of a section for a coverage of the section;
a feedback generation component that provides one or more timing signals with respect to at least one of the allocated time interval or the target time duration during the coverage of the section; and
an input component that detects an advance to another section of the presentation,
wherein the adaptive timing component updates an allocated time interval established for each of one or more remaining sections in the presentation based on a time difference between the actual presentation time duration and the allocated time interval of the section.

19. The system of claim 18, wherein the adaptive timing component further receives a change to the target time duration for the presentation during a delivery of the presentation, and updates the allocated time interval of each of the one or more remaining sections in the presentation based on an increase or a decrease in the target time duration.

20. The system of claim 18, wherein each timing signals is converted by a feedback device into a visual, an aural, a speech, or a haptic feedback that signals a passage of time being within the allocated time interval of the section, reaching an end of the allocated time interval of the section, or exceeding the allocated time interval of the section.
